(19) United States
(12) Patent Application Publication
(10) Pub. No.: US 2012/0264882 A1
(43) Pub. Date: Oct. 18, 2012

(54) Thermoplastic Resin Composition and Molded Product Using Same

(75) Inventors: Dong-Hui CHU, Uiwang-si (KR); Doo-Han HA, Uiwang-si (KR); In-Chol KIM, Uiwang-si (KR); Sung-Hun JIN, Uiwang-si (KR)

(73) Assignee: CHEIL INDUSTRIES INC., Gumi-si (KR)

(21) Appl. No.: 13/535,770

(22) Filed: Jun. 28, 2012

Related U.S. Application Data
(63) Continuation-in-part of application No. PCT/KR2010/008810, filed on Dec. 9, 2010.

(30) Foreign Application Priority Data
Dec. 29, 2009 (KR) 10-2009-0133233
Nov. 1, 2010 (KR) 10-2010-0107707

(51) Int. Cl. C08L 33/10

(52) U.S. Cl. 525/230

(57) ABSTRACT

Provided are a thermoplastic resin composition that includes (A) about 60 to about 95 wt % of a base resin including (A-1) polyalkyl(meth)acrylate resin and (A-2) a vinyl-based copolymer; and (B) about 5 to about 40 wt % of a core-shell structured copolymer including a polymer of at least two compounds selected from an aromatic vinyl compound, a vinyl cyanide compound, and an acrylic-based compound, grafted on a rubbery polymer, and a molded product using the same.

### CROSS-REFERENCE TO RELATED APPLICATIONS

This application is a continuation-in-part of International Application No. PCT/KR2010/008810, filed Dec. 9, 2010, pending, which designates the U.S., published as WO 2011/081318, and is incorporated herein by reference in its entirety, and claims priority therefrom under 35 USC Section 120. This application also claims priority under 35 USC Section 119 from Korean Patent Application No. 10-2009-0133233, filed Dec. 29, 2009, and Korean Patent Application No. 10-2010-0107707, filed Nov. 1, 2010, in the Korean Intellectual Property Office, the entire disclosure of each of which is also incorporated herein by reference.

### FIELD

This disclosure relates to a thermoplastic resin composition and a molded product using the same.

### BACKGROUND

Acrylonitrile-butadiene-styrene (ABS) resins can have excellent impact resistance and workability and good mechanical strength, thermal distortion temperature and gloss. Accordingly, ABS resins are widely used for electrical electronic parts, office equipment, and the like. However, when ABS resin is used for the housing of high-quality home equipment, such as LCDs, PDPs TVs, and stereos, the housing may scratch during injection molding or use. It can also be difficult to provide colors of high-quality texture. This can decrease the values of such products.

To solve the problem, the surface of an injection molded product formed of ABS resin may be painted with urethane, be subject to a UV coating process, or be coated with an acrylic-based resin having scratch characteristics. However, these methods require additional post processing steps, which can deteriorate productivity, increase work complexity and increase defect rates. Also the painting and coating processes may contaminate the environment.

Therefore, there is a need for a resin that may have improved gloss and impact resistance, can be readily injection molded, and has improved scratch characteristics.

### SUMMARY

One embodiment provides a thermoplastic resin composition that can have excellent scratch resistance, coloring properties, high-temperature thermal stability, impact resistance, gloss, transparency, weather resistance, workability, and the like.

Another embodiment provides a molded product using the thermoplastic resin composition.

According to one embodiment, provided is a thermoplastic resin composition that includes (A) about 60 to about 95 wt % of a base resin including (A-1) polyalkyl(meth)acrylate resin and (A-2) a vinyl-based copolymer; and (B) about 5 to about 40 wt % of a core-shell structured copolymer including a polymer of at least two compounds selected from an aromatic vinyl compound, a vinyl cyanide compound, and an acrylic-based compound, grafted on a rubbery polymer, wherein the thermoplastic resin composition includes a methyl(meth)acrylate in an amount of about 30 to about 60 wt % based on the total amount (weight) of the thermoplastic resin composition.

The polyalkyl(meth)acrylate resin (A-1) may have a weight average molecular weight of about 15,000 to about 150,000 g/mol.

The vinyl-based copolymer (A-2) may be a copolymer of an aromatic vinyl compound and a vinyl cyanide compound, such as a copolymer of about 75 to about 90 wt % of the aromatic vinyl compound and about 10 to about 25 wt % of the vinyl cyanide compound.

The base resin (A) may include about 20 to about 80 wt % of the polyalkyl(meth)acrylate resin (A-1) and about 20 to about 80 wt % of the vinyl-based copolymer (A-2).

In exemplary embodiments, the core-shell structured copolymer (B) may be a polymer (B-1) wherein a copolymer of the aromatic vinyl compound and the vinyl cyanide compound is grafted on the rubbery polymer.

The core-shell structured copolymer (B) may be a polymer (B-1) including about 20 to about 40 wt % of the aromatic vinyl compound and about 5 to about 20 wt % of the vinyl cyanide compound grafted on about 30 to about 70 wt % of the rubbery polymer.

The vinyl cyanide compound may be included in an amount of about 1 to about 20 wt %, for example about 5 to about 20 wt %, based on the total amount (weight) of the polymer of the aromatic vinyl compound and vinyl cyanide compound.

In other exemplary embodiments, the core-shell structured copolymer (B) may be a polymer (B-2) wherein a copolymer of the aromatic vinyl compound, the vinyl cyanide compound, and the acrylic-based compound is grafted on the rubbery polymer.

The core-shell structured copolymer (B) may be a polymer (B-2) including about 20 to about 40 wt % of the aromatic vinyl compound, about 5 to about 20 wt % of the vinyl cyanide compound, and about 1 to about 10 wt % of the acrylic-based compound grafted on about 30 to about 70 wt % of the rubbery polymer.

The vinyl cyanide compound may be included in an amount of about 1 to about 20 wt % based on the total amount (weight) of the polymer of the aromatic vinyl compound, vinyl cyanide compound, and the acrylic-based compound.

Examples of the rubbery polymer may include without limitation polybutadienes, polyisoprenes, polychloroprenes, butadiene-styrene copolymers, butadiene-acrylonitrile copolymers, and the like, and combinations thereof.

According to another embodiment, a molded product fabricated using the thermoplastic resin composition is provided.

The thermoplastic resin composition may have excellent scratch resistance, coloring properties, high temperature thermal stability, impact resistance, gloss, transparency, weather resistance, workability, and the like, and may be used in various electronic parts, automobile parts, miscellaneous parts, and the like.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

When a specific definition is not otherwise provided, the term “(meth)acrylate” refers to “acrylate” and “methacrylate.”

A thermoplastic resin composition according to one embodiment includes (A) a base resin including (A-1) polyalkyl(meth)acrylate resin and (A-2) a vinyl-based copolymer; and (B) a core-shell structured copolymer including a polymer of at least two compounds selected from an aromatic vinyl compound, a vinyl cyanide compound, and an acrylic-based compound, grafted on a rubbery polymer. Each component included in the thermoplastic resin composition according to embodiments of the present invention will hereinafter be described in detail.

(A) Base Resin

(A-1) Polyalkyl(meth)acrylate Resin

The polyalkyl(meth)acrylate resin can resist hydrolysis and may improve scratch resistance of a thermoplastic resin composition.

The polyalkyl(meth)acrylate resin may be obtained by polymerizing a monomer material including an alkyl(meth)acrylate through a known polymerization method, such as a suspension polymerization method, a mass (bulk) polymerization method, and an emulsion polymerization method.

The alkyl(meth)acrylate may include a C1 to C10 alkyl group. Examples of the alkyl(meth)acrylate may include without limitation methyl(meth)acrylate, ethyl(meth)acrylate, butyl(meth)acrylate, glycidyl(meth)acrylate, hydroxyethyl(meth)acrylate, and the like, and combinations thereof.

As used herein, the polyalkyl(meth)acrylate resin may include the alkyl(meth)acrylate in an amount of greater than or equal to about 50 wt %, for example about 80 to about 99 wt %, based on the total amount (weight) of the polyalkyl(meth)acrylate resin. In some embodiments, the polyalkyl(meth)acrylate resin may include the alkyl(meth)acrylate in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the alkyl(meth)acrylate can be in a range from about any of the foregoing amounts to about any other of the foregoing amounts.

When the polyalkyl(meth)acrylate resin includes the alkyl(meth)acrylate in an amount within the above range, the heat resistance of an obtained molded product can be improved, and the interaction between the molecules of a vinyl-based copolymer, which is to be described later, and the molecules of a core-shell structured copolymer can be increased and the affinity between them can be improved. Therefore, hydrolysis resistance and scratch resistance can be improved.

The monomer material may further include a vinyl-based monomer other than the alkyl(meth)acrylate. Examples of the vinyl-based monomer other than the alkyl(meth)acrylate may include without limitation aromatic vinyl monomers such as styrene, α-methylstyrene, ρ-methylstyrene, and the like; unsaturated nitrile monomers such as acrylonitrile, methacrylonitrile, and the like, and combinations thereof.

The polyalkyl(meth)acrylate resin may have a weight average molecular weight of about 10,000 to about 200,000 g/mol, for example about 15,000 to about 150,000 g/mol. When weight average molecular weight of the polyalkyl(meth)acrylate falls within the above range, the compatibility with the vinyl-based copolymer and the core-shell structured copolymer, which are to be described later, can be so excellent that the hydrolysis resistance, scratch resistance, and workability can also be excellent.

The base resin may include the polyalkyl(meth)acrylate resin in an amount of about 20 to about 80 wt %, for example about 30 to about 60 wt % based on the total amount (weight) of the base resin.

In some embodiments, the base resin may include the polyalkyl(meth)acrylate resin in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the polyalkyl(meth)acrylate resin can be in a range from about any of the foregoing amounts to about any other of the foregoing amounts.

When the polyalkyl(meth)acrylate resin is used in an amount within the above range workability, hydrolysis resistance, scratch resistance, and the like can be improved.

(A-2) Vinyl-Based Copolymer

The vinyl-based copolymer may be a copolymer of an aromatic vinyl compound and a vinyl cyanide compound.

The vinyl-based copolymer may be produced in the course of preparing the core-shell structured copolymer, which is to be described later. In exemplary embodiments, the vinyl-based copolymer may be produced when an excessive amount of a copolymer of an aromatic vinyl compound and a vinyl cyanide compound (and optionally an acrylic-based compound, such as defined herein with reference to the core-shell structured copolymer) is grafted on a small amount of a rubbery polymer or when a chain transfer agent that is used as a molecular weight controlling agent is excessively used.

Examples of the aromatic vinyl compound may include without limitation styrene, C1 to C10 alkyl-substituted styrene, halogen substituted styrene, vinyl toluene, vinyl naphthalene, and the like, and combinations thereof. Examples of the alkyl-substituted styrene may include without limitation a-methyl styrene, p-methyl styrene, o-ethyl styrene, m-ethyl styrene, p-ethyl styrene, p-t-butylstyrene, 2,4-dimethylstyrene, and the like, and combinations thereof.

Examples of the vinyl cyanide compound may include without limitation acrylonitrile, methacrylonitrile, ethacrylonitrile, and the like, and combinations thereof.

Examples of the vinyl-based copolymer may include without limitation copolymers of styrene and acrylonitrile; copolymers of α-methylstyrene and acrylonitrile; and copolymers of styrene, α-methylstyrene, and acrylonitrile. In exemplary embodiments, the vinyl-based copolymer may be a copolymer of styrene and acrylonitrile.

The vinyl-based copolymer may be prepared through an emulsion polymerization method, a suspension polymerization method, a solution polymerization method, or a mass (bulk) polymerization method, and a vinyl-based copolymer having a weight average molecular weight of about 15,000 to about 400,000 g/mol may be used.

The vinyl-based copolymer may include the vinyl cyanide compound in an amount of about 10 to about 25 wt %, for example about 15 to about 20 wt % based on the total amount (weight) of the vinyl-based copolymer (A-2).

In some embodiments, the vinyl-based copolymer may include the vinyl cyanide compound in an amount of about 10, 11, 12, 13, 14, 15, 16, 17, 18, 19, 20, 21, 22, 23, 24, or 25 wt %. Further, according to some embodiments of the present invention, the amount of the vinyl cyanide compound can be in a range from about any of the foregoing amounts to about any other of the foregoing amounts.

The vinyl-based copolymer may include the aromatic vinyl compound in an amount of about 75 to about 90 wt %, for example about 80 to about 85 wt % based on the total amount (weight) of the vinyl-based copolymer (A-2).

In some embodiments, the vinyl-based copolymer may include the aromatic vinyl compound in an amount of about 75, 76, 77, 78, 79, 80, 81, 82, 83, 84, 85, 86, 87, 88, 89, or 90 wt %. Further, according to some embodiments of the present invention, the amount of the aromatic vinyl compound can be in a range from about any of the foregoing amounts to about any other of the foregoing amounts.

When the vinyl cyanide compound and aromatic vinyl compound are included in an amount within the above ranges, coloring properties, scratch resistance, and high temperature thermal stability can be improved.

The base resin may include the vinyl-based copolymer in an amount of about 20 to about 80 wt %, for example about 40 to about 70 wt % based on the total amount (weight) of the base resin. In some embodiments, the base resin may include the vinyl-based copolymer in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the vinyl-based copolymer can be in a range from about any of the foregoing amounts to about any other of the foregoing amounts.

When the vinyl-based copolymer is included in an amount within the above range, workability, impact resistance, scratch resistance, and the like can be improved.

The thermoplastic resin composition can include the base resin (A) including the polyalkyl(meth)acrylate resin (A-1) and the vinyl-based copolymer (A-2) in an amount of about 60 to about 95 wt %, for example about 80 to about 90 wt % based on the total amount (weight) of the thermoplastic resin composition. In some embodiments, the thermoplastic resin composition can include the base resin (A) including the polyalkyl(meth)acrylate resin (A-1) and the vinyl-based copolymer (A-2) in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the base resin can be in a range from about any of the foregoing amounts to about any other of the foregoing amounts.

When the base resin is included in an amount within the above range, impact resistance, scratch resistance, coloring properties, high temperature thermal stability, and the like can be improved.

(B) Core-Shell Structured Copolymer

The core-shell structured copolymer may be a copolymer including a polymer of at least two compounds selected from an aromatic vinyl compound, a vinyl cyanide compound, and an acrylic-based compound, grafted on a rubbery polymer.

The core-shell structured copolymer may be (B-1) a copolymer including a polymer of an aromatic vinyl compound and a vinyl cyanide compound that is grafted on a rubbery polymer, or (B-2) a copolymer including a polymer of an aromatic vinyl compound, a vinyl cyanide compound, and an acrylic-based compound that is grafted on a rubbery polymer.

The rubbery polymer may be a diene-based compound. Examples of the diene-based compound include without limitation polybutadiene, polyisoprene, polychloroprene, butadiene-styrene copolymer, butadiene-acrylonitrile copolymer, and the like, and combinations thereof. In exemplary embodiments, the diene-based compound may be polybutadiene, a butadiene-styrene copolymer, a butadiene-acrylonitrile copolymer, or a combination thereof.

A rubber particle that is formed of the rubbery polymer may have an average particle diameter of about 0.1 to about 0.6 μm, for example about 0.2 to about 0.5 μm. When the rubber particle has an average particle diameter within the above range, impact strength may be improved.

Examples of the aromatic vinyl compound may include without limitation styrene, C1 to C10 alkyl-substituted styrene, halogen substituted styrene, vinyl toluene, vinyl naphthalene, and the like, and combinations thereof. Examples of the alkyl-substituted styrene may include without limitation α-methyl styrene, p-methyl styrene, o-ethyl styrene, m-ethyl styrene, p-ethyl styrene, p-t-butylstyrene, 2,4-dimethylstyrene, and the like, and combinations thereof.

Examples of the vinyl cyanide compound may include without limitation acrylonitrile, methacrylonitrile, ethacrylonitrile, and the like, and combinations thereof.

Examples of the acrylic-based compound may include without limitation (meth)acrylic acid alkyl esters, (meth)acrylic acid esters, and the like, and combinations thereof. As used herein, the alkyl may be a C1 to C10 alkyl.

Examples of the (meth)acrylic acid alkyl ester may include without limitation methyl(meth)acrylate, ethyl(meth)acrylate, propyl(meth)acrylate, butyl(meth)acrylate, and the like, and combinations thereof. In exemplary embodiments, methyl(meth)acrylate may be used. Examples of the (meth)acrylic acid ester may include (meth)acrylate, and the like.

The core-shell structured copolymer (B-1) may include a polymer of an aromatic vinyl compound and a vinyl cyanide compound that is grafted on a rubbery polymer. The copolymer (B-1) may include about 20 to about 40 wt % of the aromatic vinyl compound and about 5 to about 20 wt % of the vinyl cyanide compound grafted on about 30 to about 70 wt % of the rubbery polymer. For example, the copolymer (B-1) may include about 25 to about 35 wt % of the aromatic vinyl compound and about 10 to about 15 wt % of the vinyl cyanide compound grafted on about 50 to about 60 wt % of the rubbery polymer.

In some embodiments, the copolymer (B-1) may include the aromatic vinyl compound in an amount of about 20, 21, 22, 23, 24, 25, 26, 27, 28, 29, 30, 31, 32, 33, 34, 35, 36, 37, 38, 39, or 40 wt %. Further, according to some embodiments of the present invention, the amount of the aromatic vinyl compound can be in a range from about any of the foregoing amounts to about any other of the foregoing amounts.

In some embodiments, the copolymer (B-1) may include the vinyl cyanide compound in an amount of about 5, 6, 7, 8, 9, 10, 11, 12, 13, 14, 15, 16, 17, 18, 19, or 20 wt %. Further, according to some embodiments of the present invention, the amount of the vinyl cyanide compound can be in a range from about any of the foregoing amounts to about any other of the foregoing amounts.

In some embodiments, the copolymer (B-1) may include the rubbery polymer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the rubbery polymer can be in a range from about any of the foregoing amounts to about any other of the foregoing amounts.

When the copolymer (B-1) is formed the components noted herein in amounts within the above ranges, high temperature thermal stability, impact resistance, coloring properties, and the like may be improved.

In the copolymer (B-1), the vinyl cyanide compound may be included in an amount of about 1 to 20 wt %, for example about 5 to about 20 wt %, and as another example about 5 to about 15 wt %, based on the total amount (weight) of the polymer of the aromatic vinyl compound and vinyl cyanide compound. In some embodiments, the vinyl cyanide compound may be included in an amount of about 1, 2, 3, 4, 5, 6, 7, 8, 9, 10, 11, 12, 13, 14, 15, 16, 17, 18, 19, or 20 wt %. Further, according to some embodiments of the present invention, the amount of the vinyl cyanide compound can be in a range from about any of the foregoing amounts to about any other of the foregoing amounts.

When the vinyl cyanide compound is included in an amount within the above range, high temperature thermal stability, and coloring properties may be improved.

In the copolymer (B-1), examples of the polymer of the aromatic vinyl compound and vinyl cyanide compound may include without limitation a polymer of styrene and acrylonitrile; a polymer of α-methylstyrene and acrylonitrile; a polymer of styrene, α-methylstyrene, and acrylonitrile, and the like, and combinations thereof. In exemplary embodiments, the polymer of the aromatic vinyl compound and vinyl cyanide compound may a polymer of styrene and acrylonitrile.

The copolymer (B-1) can include a copolymer where a polymer of styrene and acrylonitrile is grafted on polybutadiene.

The core-shell structured copolymer (B-2) may include a polymer of an aromatic vinyl compound, a vinyl cyanide compound and an acrylic-based compound that is grafted on a rubbery polymer. The copolymer (B-2) may include about 20 to about 40 wt % of the aromatic vinyl compound, about 5 to about 20 wt % of the vinyl cyanide compound, and about 1 to about 10 wt % of the acrylic-based compound grafted on about 30 to about 70 wt % of the rubbery polymer. For example, the copolymer (B-2) may include about 20 to about 25 wt % of the aromatic vinyl compound, about 5 to about 10 wt % of the vinyl cyanide compound and about 5 to about 10 wt % of the acrylic-based compound grafted on about 50 to about 60 wt % of the rubbery polymer.

In some embodiments, the copolymer (B-2) may include the aromatic vinyl compound in an amount of about 20, 21, 22, 23, 24, 25, 26, 27, 28, 29, 30, 31, 32, 33, 34, 35, 36, 37, 38, 39, or 40 wt %. Further, according to some embodiments of the present invention, the amount of the aromatic vinyl compound can be in a range from about any of the foregoing amounts to about any other of the foregoing amounts.

In some embodiments, the copolymer (B-2) may include the vinyl cyanide compound in an amount of about 5, 6, 7, 8, 9, 10, 11, 12, 13, 14, 15, 16, 17, 18, 19, or 20 wt %. Further, according to some embodiments of the present invention, the amount of the vinyl cyanide compound can be in a range from about any of the foregoing amounts to about any other of the foregoing amounts.

In some embodiments, the copolymer (B-2) may include the acrylic-based compound in an amount of about 1, 2, 3, 4, 5, 6, 7, 8, 9, or 10 wt %. Further, according to some embodiments of the present invention, the amount of the acrylic-based compound can be in a range from about any of the foregoing amounts to about any other of the foregoing amounts.

In some embodiments, the copolymer (B-2) may include the rubbery polymer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the rubbery polymer can be in a range from about any of the foregoing amounts to about any other of the foregoing amounts.

When the copolymer (B-2) is formed with the above components in amounts within the above ranges, high-temperature thermal stability, impact resistance, coloring properties, and the like may be improved.

In the copolymer (B-2), the vinyl cyanide compound may be included in an amount of about 1 to about 20 wt %, for example about 5 to about 20 wt %, and as another example about 5 to about 15 wt % based on the total amount (weight) of the polymer of the aromatic vinyl compound, vinyl cyanide compound, and the acrylic-based compound. In some embodiments, the vinyl cyanide compound may be included in an amount of about 1, 2, 3, 4, 5, 6, 7, 8, 9, 10, 11, 12, 13, 14, 15, 16, 17, 18, 19, or 20 wt %. Further, according to some embodiments of the present invention, the amount of the vinyl cyanide compound can be in a range from about any of the foregoing amounts to about any other of the foregoing amounts.

When the vinyl cyanide compound is included in an amount within the above range, high temperature thermal stability, and coloring properties may be improved.

In the copolymer (B-2), examples of the polymer of the aromatic vinyl compound, vinyl cyanide compound, and acrylic-based compound may include without limitation a polymer of styrene, acrylonitrile, and methylmethacrylate; a polymer of α-methylstyrene, acrylonitrile, and methylmethacrylate; a polymer of styrene, α-methylstyrene, acrylonitrile, and methylmethacrylate, and the like, and combinations thereof. In exemplary embodiments, the polymer of the aromatic vinyl compound, vinyl cyanide compound, and acrylic-based compound may a polymer of styrene, acrylonitrile, and methylmethacrylate.

The copolymer (B-2) may include a copolymer wherein a polymer of styrene, acrylonitrile, and methylmethacrylate is grafted on polybutadiene.

The method of preparing the core-shell structured copolymer is widely known to those skilled in the art, and any one among the emulsion polymerization method, the suspension polymerization method, the solution polymerization method and the mass (bulk) polymerization method may be used. In exemplary embodiments, the core-shell structured copolymer may be prepared by adding an aromatic vinyl compound and a vinyl cyanide compound to a rubbery polymer, using a polymerization initiator, and performing an emulsion polymerization or a mass polymerization.

The thermoplastic resin composition may include the core-shell structured copolymer in an amount of about 5 to about 40 wt %, for example about 10 to about 20 wt %, based on the total amount (weight) of the thermoplastic resin composition. In some embodiments, the thermoplastic resin composition may include the core-shell structured copolymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the core-shell structured copolymer can be in a range from about any of the foregoing amounts to about any other of the foregoing amounts.

When the core-shell structured copolymer is included in an amount within the above range, impact resistance, scratch resistance, gloss, and the like may be improved.

(C) Other Additive(s)

The thermoplastic resin composition according to one embodiment may include one or more additives. Examples of the additives include without limitation antibacterial agents, heat stabilizers, antioxidants, release agents, light stabilizers, surfactants, coupling agents, plasticizers, admixtures, weather-resistance agents, colorants, stabilizers, lubricants, antistatic agents, coloring aids, flameproofing agents, ultraviolet (UV) absorbers, ultraviolet (UV) blocking agents, nucleating agents, adhesion aids, adhesives, and the like and combinations thereof.

Examples of the antioxidant may include without limitation phenol antioxidants, phosphite antioxidants, thioether antioxidants, amine antioxidants, and the like, and combinations thereof. Examples of the release agent may include without limitation fluorine-included polymers, silicon oils, stearic metal salts, montanic metal salts, montanic ester waxes, polyethylene waxes, and the like, and combinations thereof. Examples of the weather-resistance agent may include without limitation benzophenone-type weather-resistance agents, amine-type weather-resistance agents, and the like, and combinations thereof. Examples of the colorant may include without limitation dyes, pigments, and the like, and combinations thereof. Examples of the ultraviolet (UV) ray blocking agent may include without limitation titanium oxide (TiO₂), carbon black, and the like, and combinations thereof. Examples of the nucleating agent may include without limitation talc, clay, and the like, and combinations thereof.

The additive may be included in a predetermined amount as long as it does not deteriorate the properties of the thermoplastic resin composition. In exemplary embodiments, the thermoplastic resin composition may include the additive in an amount of less than or equal to about 40 parts by weight, for example about 0.1 to about 30 parts by weight based on about 100 parts by weight of the thermoplastic resin composition.

When the aforementioned thermoplastic resin composition is analyzed through ¹H-NMR spectroscopy, the thermoplastic resin composition includes methyl(meth)acrylate. Herein, the methyl(meth)acrylate may be included in an amount of about 30 to about 60 wt %, for example about 40 to about 50 wt % based on the total amount (weight) of the thermoplastic resin composition.

The aforementioned thermoplastic resin composition may have a pencil hardness of F to 3H measured based on JIS K5401, R-hardness of about 110 to about 123 measured based on ASTM D785, and IZOD impact strength of about 7 to about 20 kgf·cm/cm measured based on ASTM D256.

The thermoplastic resin composition may be prepared using any well-known method of preparing a resin composition. For example, each component according to one embodiment of the present invention can be simultaneously mixed, optionally with one or more additives. The mixture can be melt-extruded and prepared as pellets.

According to another embodiment of the present invention, a molded product fabricated using the thermoplastic resin composition is provided. The thermoplastic resin composition can be used to manufacture a molded product using various known processes such as injection molding, blow molding, extrusion molding, thermal molding, and the like. For example, the thermoplastic resin composition may be used to make various electronic parts, automobile parts, miscellaneous parts, and the like that require excellent scratch resistance, coloring properties, high temperature thermal stability, impact resistance, gloss, weather resistance, workability, and the like.

The following examples illustrate this invention in more detail. However, it is understood that this invention is not limited by these examples.

### EXAMPLES

A thermoplastic resin composition according to one embodiment includes each component as follows.

(A) Base Resin

(A-1) Polyalkyl(meth)acrylate Resin

PM-7200 of Cheil Industries INC. is used as a polymethylmethacrylate (PMMA) resin having a weight average molecular weight of 85,000 g/mol.

(A-2) Vinyl-Based Copolymer

(A-2-1) A styrene-acrylonitrile (SAN) resin including 15 wt % of acrylonitrile and having a weight average molecular weight of 100,000 g/mol is used.

(A-2-2) A styrene-acrylonitrile (SAN) resin including 20 wt % of acrylonitrile and having a weight average molecular weight of 84,000 g/mol is used.

(B) Core-Shell Structured Copolymer

(B-1) An acrylonitrile-butadiene-styrene (g-ABS) copolymer wherein 32 wt % of styrene and 10 wt % of acrylonitrile are grafted on 58 wt % of polybutadiene with an average rubber particle diameter of 0.4 μm is used.

(B-2) An acrylonitrile-butadiene-styrene (g-ABS) copolymer wherein 30 wt % of styrene, 7 wt % of acrylonitrile, and 5 wt % of methylmethacrylate are grafted on 58 wt % of polybutadiene with an average rubber particle diameter of 0.4 μm is used.

(C) Carbon Black

HI-BLACK 50L of Evonik Industries is used as carbon black.

### Examples 1 to 10 and Comparative Examples 1 to 4

The thermoplastic resin compositions according to Examples 1 to 10 and Comparative Examples 1 to 4 are prepared using the components described above the following Table 1 according to the amounts described in Tables 1 and 2.

As for the manufacturing method, the components are mixed in the amounts shown in the following Tables 1 and 2 and extruded using a conventional twin-screw extruder at a temperature of 210 to 230° C. into pellets.

The manufactured pellets are dried at 80° C. for 4 hours, and then specimens are prepared by setting a cylinder temperature at 240° C., a molding temperature at 60° C., and a molding cycle time at 40 seconds, and injection-molding the pellets into an ASTM dumb-bell specimen with an injection molding machine capable of 6 oz injection. The physical properties of the prepared physical property specimens are measured in accordance with the following methods, and the measurement results are shown in the following Tables 1 and 2.

(1) Analysis of the content of methyl(meth)acrylate: The amount of methyl(meth)acrylate is measured through ¹H-NMR spectroscopy. A calibration curve is obtained using samples whose exact input amount is known, and then the amounts of the methylmethacrylate in the prepared physical property specimens are measured using 500 MHz H-NMR of Bruker Corporation.

(2) IZOD impact strength: IZOD impact strength is measured in accordance with ASTM D256 (specimen thickness ⅛″).

(3) Gloss: Gloss is measured in accordance with ASTM D523.

(4) R-hardness: R-hardness is measured in accordance with ASTM D785.

(5) Pencil hardness: A specimen having a thickness of 3 mm, length of 10 mm and width of 10 mm is prepared, and then a load of 500 g is applied to the surface of the specimen five times at 23° C. based on JIS K5401, and the extent of scratching is observed with the naked eye. When the pencil scratch is formed more than two times, the pencil hardness is decided on the scale of 4B to 7H.

(6) Fluidity: Fluidity of 10 kg of specimen is measured at 220° C. in accordance with IS01103.

(7) Transparency: Transparency is measured with a color computer measurement equipment of Japanese Suga Instrument Co., Ltd., and the measurement results are presented as Haze based on total transmittance determined as shown in the following Equations 1 and 2.

Total transmittance (%)=(specimen transmission light)/(specimen radiation light)×100 [Equation 1]

Haze (%)=(disperse transmission light)/(total transmittance)×100 [Equation 2]

(8) Coloring properties: A dL value is measured and evaluated using a colorimeter. As used herein, if the dL value is in the minus direction, brightness is decreased so as to realize deep black characteristics and have excellent coloring properties. Also, it is observed with the naked eye.

(9) High temperature thermal stability: 150 Ton injection molding equipment of Dongshin Hydraulics Co. is used, and the resin is held at a cylinder temperature of 270° C. for 10 minutes, and then the amount of gas silver generated in the consecutively injected specimens is evaluated with the naked eye. As used herein, the dL values of the specimens after being held are evaluated based on the specimens before being held, and also their appearance levels are evaluated with the naked eye. As used herein, if the dL value is in the plus direction, it means that the deep black characteristics are deteriorated and high-temperature thermal stability is deteriorated. The mold is a pin-point mold.
gas silver: ⊚—not generated, ∘—slightly generated, Δ—generated, x—generated very much
Naked eye: ⊚—excellent, ∘—excellent, Δ—deteriorated, x—deteriorated very much

TABLE 1

| | | | Examples | | | | | | | | | |
|---|---|---|---|---|---|---|---|---|---|---|---|---|
| | | | 1 | 2 | 3 | 4 | 5 | 6 | 7 | 8 | 9 | 10 |
| (A) | (A-1) polyalkyl(meth)acrylate | | 35 | 40 | 50 | 60 | 40 | 50 | 35 | 40 | 50 | 60 |
| base | resin (wt %) | | | | | | | | | | | |
| resin | (A-2) | (A-2-1) | 55 | 40 | 40 | 20 | — | — | 55 | 40 | 40 | 20 |
| | vinyl-based | (A-2-2) | — | — | — | — | 40 | 40 | — | — | — | — |
| | copolymer | | | | | | | | | | | |
| | (wt %) | | | | | | | | | | | |

| | | | | | | | | | | | |
|---|---|---|---|---|---|---|---|---|---|---|---|
| (B) core-shell | (B-1) | 10 | 20 | 10 | 20 | 20 | 10 | — | — | — | — |
| structured | (wt %) | | | | | | | | | | |
| copolymer | (B-2) | — | — | — | — | — | — | 10 | 20 | 10 | 20 |
| | (wt %) | | | | | | | | | | |

| (C) carbon black (parts by weight*) | | 0.1 | 0.1 | 0.1 | 0.1 | 0.1 | 0.1 | 0.1 | 0.1 | 0.1 | 0.1 |
|---|---|---|---|---|---|---|---|---|---|---|---|
| methyl(meth)acrylate (wt %**) | | 33 | 38 | 48 | 57 | 38 | 48 | 33 | 38 | 48 | 57 |
| IZOD impact strength (kgf · cm/cm) | | 9 | 15 | 8 | 16 | 15 | 9 | 7 | 13 | 6 | 14 |
| Gloss (%) | | 95 | 95 | 96 | 97 | 96 | 96 | 96 | 95 | 97 | 97 |
| R-hardness | | 116 | 115 | 117 | 117 | 115 | 117 | 116 | 115 | 117 | 117 |
| Pencil hardness | | H | H | 2H | H | H | 2H | H | F | H | H |
| Fluidity (g/10 min) | | 16 | 11 | 14 | 10 | 10 | 13 | 15 | 10 | 13 | 10 |
| Haze (%) | | 12 | 15 | 10 | 12 | 13 | 10 | 8 | 12 | 7 | 11 |
| Coloring | Naked eye | ◯ | ◯ | ⊚ | ◯ | ◯ | ⊚ | ⊚ | ⊚ | ⊚ | ⊚ |
| properties | dL | −2 | −2 | −2 | −2 | −2 | −2 | −1 | −2 | −1 | −1 |
| High | gas silver | ◯ | ⊚ | ⊚ | ◯ | ◯ | ⊚ | ◯ | ⊚ | ⊚ | ◯ |
| temperature | dL | −0.1 | −0.1 | 0.0 | 0.1 | 0.1 | 0.0 | 0.0 | 0.1 | 0.0 | 0.1 |
| thermal | Naked eye | ⊚ | ⊚ | ⊚ | ◯ | ◯ | ⊚ | ⊚ | ⊚ | ⊚ | ◯ |
| stability | | | | | | | | | | | |

TABLE 2

| | | | Comparative | | | |
|---|---|---|---|---|---|---|
| | | | Examples | | | |
| | | | 1 | 2 | 3 | 4 |
| (A) | (A-1) | | 50 | 50 | — | 80 |
| base resin | polyalkyl(meth)acrylate | | | | | |
| | resin (wt %) | | | | | |
| | (A-2) | (A-2-1) | 50 | — | 80 | — |
| | vinyl-based | (A-2-2) | — | 50 | — | — |
| | copolymer | | | | | |
| | (wt %) | | | | | |

| | | | | | |
|---|---|---|---|---|---|
| (B) core-shell | (B-1) Copolymer (wt %) | — | — | 20 | 20 |
| structured | (B-2) Copolymer (wt %) | — | — | — | — |
| copolymer | | | | | |

| (C) carbon black(parts by weight*) | | 0.1 | 0.1 | 0.1 | 0.1 |
|---|---|---|---|---|---|
| Amount of methyl(meth)acrylate (wt %**) | | 48 | 48 | — | 76 |
| IZOD impact strength (kgf · cm/cm) | | 1 | 1 | 21 | 5 |
| Gloss (%) | | 98 | 98 | 92 | 91 |
| R-hardness | | 120 | 121 | 108 | 118 |
| Pencil hardness | | 3H | 3H | 2B | 2H |
| Fluidity (g/10 min) | | 18 | 16 | 7 | 6 |
| Haze (%) | | 22 | 25 | 78 | 80 |
| Coloring properties | Naked eye | ◯ | ◯ | Δ | Δ |
| | dL | −1.8 | −1.5 | −0.7 | −0.8 |
| High-temperature | gas silver | ◯ | ◯ | X | X |
| thermal stability | dL | 0.6 | 0.9 | 1.5 | 2.5 |
| | Naked eye | ◯ | ◯ | Δ | X |

*parts by weight: the unit of an amount represented based on the total amount of the base resin (A) and the core-shell structured copolymer (B) as 100 parts by weight.
**wt %: the unit of an amount of methyl(meth)acrylate among the total amount of the base resin (A) and the core-shell structured copolymer (B).

It may be seen from Tables 1 and 2 that Examples 1 to 10 which use thermoplastic resin compositions including the polyalkyl(meth)acrylate resin, the vinyl-based copolymer, and the core-shell structured copolymer wherein the polymer of at least two compounds among the aromatic vinyl compound, the vinyl cyanide compound, and the acrylic-based compound, is grafted on the rubbery polymer, according to one embodiment, and included an appropriate amount of methyl(meth)acrylate in the thermoplastic resin composition, exhibit excellent physical properties balance, such as impact resistance, gloss, transparency, scratch resistance, workability, coloring properties, and high temperature thermal stability, compared with Comparative Examples 1 to 4. Since the examples exemplifying the invention have excellent gloss, scratch resistance, and coloring properties, they do not have to be subject to post processing steps such a UV coating process or an acrylic-based resin film attaching process.

In contrast, Comparative Examples 1 and 2 that did not include the core-shell structured copolymer exhibits excellent gloss, scratch resistance and coloring properties but deteriorated impact resistance and workability. Also, Comparative Example 3 that did not include the polyalkyl(meth)acrylate resin exhibits excellent impact resistance but deteriorated gloss, scratch resistance and coloring properties, and thus is not appropriate for a paint-less process. Also, Comparative Example 4 that did not include the vinyl-based copolymer exhibits deteriorated impact resistance and high-temperature thermal stability.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition, comprising
(A) about 60 to about 95 wt % of a base resin including (A-1) polyalkyl(meth)acrylate resin and (A-2) a vinyl-based copolymer; and
(B) about 5 to about 40 wt % of a core-shell structured copolymer including a polymer including at least two compounds selected from an aromatic vinyl compound, a vinyl cyanide compound, and an acrylic-based compound, grafted on a rubbery polymer,
wherein the thermoplastic resin composition includes a methyl(meth)acrylate in an amount of about 30 to about 60 wt % based on the total weight of the thermoplastic resin composition.

2. The thermoplastic resin composition of claim 1, wherein the polyalkyl(meth)acrylate resin (A-1) has a weight average molecular weight of about 15,000 to about 150,000 g/mol.

3. The thermoplastic resin composition of claim 1, wherein the vinyl-based copolymer (A-2) is a copolymer of an aromatic vinyl compound and a vinyl cyanide compound.

4. The thermoplastic resin composition of claim 3, wherein the vinyl-based copolymer (A-2) is a copolymer of about 75 to about 90 wt % of the aromatic vinyl compound and about 10 to about 25 wt % of the vinyl cyanide compound.

5. The thermoplastic resin composition of claim 1, wherein the base resin (A) comprises about 20 to about 80 wt % of the polyalkyl(meth)acrylate resin (A-1) and about 20 to about 80 wt % of the vinyl-based copolymer (A-2).

6. The thermoplastic resin composition of claim 1, wherein the core-shell structured copolymer (B) includes a polymer of the aromatic vinyl compound and the vinyl cyanide compound grafted on the rubbery polymer.

7. The thermoplastic resin composition of claim 1, wherein the core-shell structured copolymer (B) includes a polymer of the aromatic vinyl compound, the vinyl cyanide compound, and the acrylic-based compound grafted on the rubbery polymer.

8. The thermoplastic resin composition of claim 6, wherein the core-shell structured copolymer (B) includes about 20 to about 40 wt % of the aromatic vinyl compound and about 5 to about 20 wt % of the vinyl cyanide compound grafted on about 30 to about 70 wt % of the rubbery polymer.

9. The thermoplastic resin composition of claim 6, wherein the vinyl cyanide compound is included in an amount of about 1 to about 20 wt % based on the total weight of the polymer of the aromatic vinyl compound and vinyl cyanide compound.

10. The thermoplastic resin composition of claim 6, wherein the vinyl cyanide compound is included in an amount of about 5 to about 20 wt % based on the total weight of the polymer of the aromatic vinyl compound and vinyl cyanide compound.

11. The thermoplastic resin composition of claim 7, wherein the core-shell structured copolymer (B) includes about 20 to about 40 wt % of the aromatic vinyl compound, about 5 to about 20 wt % of the vinyl cyanide compound and about 1 to about 10 wt % of the acrylic-based compound grafted on about 30 to about 70 wt % of the rubbery polymer.

12. The thermoplastic resin composition of claim 7, wherein the vinyl cyanide compound is included in an amount of about 1 to about 20 wt % based on the total amount of the polymer of the aromatic vinyl compound, vinyl cyanide compound, and the acrylic-based compound.

13. The thermoplastic resin composition of claim 1, wherein the rubbery polymer comprises polybutadiene, polyisoprene, polychloroprene, a butadiene-styrene copolymer, a butadiene-acrylonitrile copolymer, or a combination thereof.

14. A molded product fabricated using the thermoplastic resin composition according to claim 1.
